(19) United States
(12) Patent Application Publication
(10) Pub. No.: US 2011/0004719 A1
(43) Pub. Date: Jan. 6, 2011

(54) Memory Element

(75) Inventor: Richard Fitzgerald, Edinburgh (GB)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/487,129

(22) Filed: Jun. 18, 2009

(30) Foreign Application Priority Data
Jun. 19, 2008 (GB) 0811293.0

(51) Int. Cl. G06F 12/06

(52) U.S. Cl. 711/1; 711/103; 711/E12.084

(57) ABSTRACT

Disclosed is memory apparatus (20) in which an area (34) of a memory element (24) is reserved for configuration data relating to parameters of the memory apparatus (20), the area (34) being accessible using a command issued by a device driver (10). Including the configuration data in the memory apparatus (20) simplifies the design and maintenance of the device driver (10).

### RELATED APPLICATIONS

This application was originally filed as and claims priority to Great Britain Application No. 0811293.0 filed on 19 Jun. 2008.

### TECHNICAL FIELD

Examples of the present invention relate to a memory element.

### BACKGROUND

Memory chips such as Flash memory are known. Usually a Flash memory chip is incorporated as part of a memory drive, including a dedicated controller that communicates with a host to allow the host to access the memory chip. Alternatively, when the Flash memory chip is embedded in a host device, the host device usually requires a memory device driver that knows the operating parameters of the memory. To use memory chips of different types can require that the memory driver store many sets of operating parameters.

### SUMMARY OF EXAMPLES OF THE INVENTION

One example of the invention relates to a memory chip having a reserved area of memory in which is stored configuration data for the memory chip. The configuration data is provided to a memory device driver in a host device when required. Thereafter the memory device driver operates the memory chip using the provided configuration data.
i. In one example the configuration data relates to various operating parameters of the memory chip. In one example the operating parameters includes parameters relating to the size or number of memory elements or areas in the memory chip. The parameters relating to the size of memory elements or areas in the memory chip include as examples any of: the size of memory pages in the memory chip, the number of pages per block of memory, or the number of sectors per page. In the same or another example the operating parameters include parameters relating to timing information for the memory chip. The operating parameters relating to timing information include as examples any of: the time taken by the device to erase a unit of memory, or to write to a unit of memory, or to read from a unit of memory.

In another example there is provided an apparatus comprising: a memory element having a plurality of memory areas, at least one of said memory areas being reserved for configuration data of the memory element; and an input configured to receive a command issued by a memory apparatus device driver to access the configuration data in the reserved area.

In one example the memory element is a memory chip having plural memory areas in which data is stored and accessed from. The memory element in this example is arranged in one or more blocks of memory, each block comprising one or more pages.

In one example the area of the memory element which is reserved for the configuration data is a predefined area. The predefined area of the memory element which is reserved for the configuration data of the memory apparatus in another example is in a safe area of the memory apparatus.

Where the configuration data is in a safe area, in an example of the invention the safe area of the memory apparatus may be a safe page of the memory apparatus.

Furthermore, in an example of the invention the predefined area of the memory element which is reserved for the configuration data of the memory apparatus is in a spare area of the safe page.

In a further example the predefined area of the memory element is in a first page of the memory apparatus.

In another example the area of the memory element which is reserved for the configuration data is separate from an area of the memory element which is used for storing user data.

In yet another example the area of the memory element which is reserved for the configuration data is read-only.

In a further example the command may comprise an identification request and a memory address.

In a yet further example the memory address may be a dummy address.

In another example the command comprises an identification request and the address of the predefined area.

Alternatively, in another example the command requests the address of the predefined area. Thus, if the address of the predefined area is not known to the driver, it can request the address and subsequently read the configuration data from the address returned by the memory apparatus.

Alternatively, in a further example the command is a specific configuration request command which, when received by the memory apparatus, causes the memory apparatus to return the configuration data.

In a further example the memory apparatus may be a NAND flash memory apparatus.

According to another example of the invention there is provided a method comprising issuing a command to a memory element so as to access configuration data stored in the memory element relating to characteristics of the memory element; and receiving in response to the command data pertaining to one or more characteristics of the configuration data.

According to a further example, there is also provided a memory apparatus device driver configured to access an area of a memory element of a memory apparatus to obtain memory configuration data therefrom. The memory apparatus device driver can then use the configuration data to access the memory element so as to read data therefrom or write data thereto.

A further example of the invention also provides an apparatus comprising: a memory element having a plurality of memory areas, at least one of said memory areas having configuration data relating to the memory element stored therein; an interface configured to communicate with the memory element so as to access the memory areas therein; and a higher-level application that uses the memory element to store data; wherein the interface is configured to issue a command to the memory element so as to access the configuration data stored in the memory element, and thereafter uses the configuration data to access the memory areas therein.

### BRIEF DESCRIPTION OF THE DRAWINGS

Embodiments of the invention will now be described, strictly by way of example only, with reference to the accompanying drawings, of which:

FIG. 1 is a schematic illustration of the interaction between an application, a flash memory device driver and a flash memory device for a consumer product which uses the flash memory device to store data;

FIG. 2 is a schematic illustration of a memory apparatus for a consumer product such as a mobile telephone, digital camera or the like; and

FIG. 3 is a flow diagram illustrating actions taken by a product which uses the memory apparatus of FIG. 2.

### DESCRIPTION OF THE EMBODIMENTS

Flash memory is commonly used for storing data in consumer products such as mobile telephones, digital cameras and the like, as well as in removable memory cards which can be used with such products to facilitate the transfer of data from the product to another product such as a personal computer or the like.

Commonly a Flash memory chip may be included as part of a memory drive, for example a USB memory drive, that operates in accordance with the USB Mass Storage Device class. In such a case a controller is provided as part of the memory drive, to allow a host device to access the memory chip. Data relating to operational parameters of the memory chip are stored in the controller, and the controller acts as an interface between a host device and the memory chip.

Flash memory chips may also be embedded within devices, such as mobile telephones and digital cameras as well as many other types of device. In such cases, commonly a memory device driver will be used by the host device to access the memory. The memory device driver is required to know the operating parameters of the memory to allow operation. Where memory chips having different operating characteristics may be used in the construction of the device, the memory device driver is often required to store multiple sets of operating parameters.

There are two main categories of flash memory, NOR memory and NAND memory. NAND memory is most frequently used in consumer products, as it is cheaper, faster to write to and typically higher capacity than NOR memory.

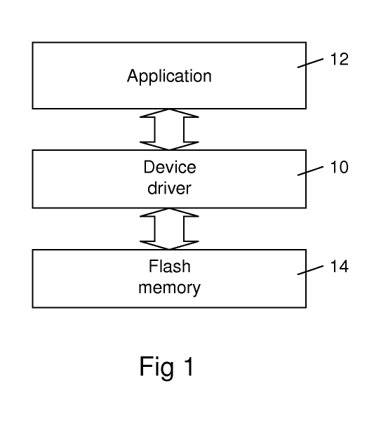

NAND memory is arranged in blocks, each of which contains one or more pages. Pages may typically have a capacity of 512, 2048 or 4096 bytes. NAND memory has a standard set of commands which allow data to be written to and read or erased from the NAND memory. These commands are issued by a flash memory device driver, shown at 10 in FIG. 1, which is a piece of software which communicates with a higher level application 12 running on the product to permit access by the application to the NAND memory 14.

A difficulty with existing NAND memory devices is that there is no command in the standard command set which allows configuration data of the memory device (also known as “geometry data”), which comprises information relating to parameters of the memory device to be accessed by the product in which the memory device is used. This configuration data may include, for example, information such as the length in bytes of the memory address field used to access the contents of the NAND device, information on whether the device uses small or large blocks of memory (as the command set, page layout and bad block marking are different for these different types of devices), details of the size in bytes of pages of memory and the number of pages per block, the number of sectors per page and the number of blocks in the device. The configuration data may also include timing information such as the time taken by the device to erase the memory and to implement particular commands.

Some manufacturers provide additional commands to permit direct access to the configuration data, but these are non-standard, and may differ from manufacturer to manufacturer, and the format in which data is returned by these non-standard commands differs from manufacturer to manufacturer. Thus, to ensure that products are compatible with NAND memory devices produced by different manufacturers, as mentioned previously device drivers 10 used in products typically include look-up tables which list the device identifiers of known NAND flash memory devices 14 against the configuration data for the memory device 14 associated with the device identifier. The product using the memory device 14 issues a command, via the device driver 10, requesting that the memory device 14 returns its device identifier, and this identifier is used to index the look up table to obtain the configuration data for the particular memory device 14. A difficulty with this approach is that if it is desired for the product to support a new or alternative NAND flash memory device 14 (from a new or alternative manufacturer, for example), the device driver 10 must be rebuilt to include the configuration data and device identifier of the new memory device 14 in the look up table. This restricts the number of different types of NAND flash memory device 14 that can be supported by the product, as new devices may not necessarily be supported. This makes it difficult for manufacturers of products in which NAND flash memory devices 14 are employed to “second-source” NAND flash memory devices 14 (i.e. to use devices obtained from an alternative supplier), as the configuration data of every possible alternative NAND flash memory device 14 must be known for a driver 10 which is compatible with every possible alternative to be provided. Additionally, the look up table typically contains a large amount of data, and this increases the size of the driver 10. Moreover, manufacturers of products which use NAND flash memory devices 14 such as mobile telephones typically use a standard device driver 10 in different products, for example different models of mobile telephones which use the same operating system. These different products may each use different NAND flash memory devices 14, and thus the device driver 10 must be compatible with every possible NAND flash memory device 14 with which the device driver 10 will be used. However, hard-coding look-up tables in the device driver 10 to ensure that it is compatible with every possible NAND flash device 14 is undesirable for the manufacture of the device driver 10, as it is a difficult and time-consuming process.

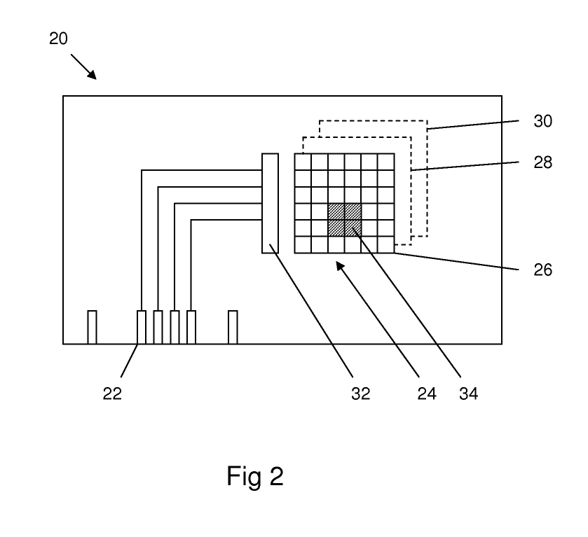

Referring to FIG. 2, a memory apparatus according to an example of the invention is shown generally at 20. The memory apparatus 20 could be used in a consumer product such as a mobile telephone, digital camera or the like to store data such as executable program code and user data such as contact information, photographs, music and the like. In this example the memory apparatus 20 has a plurality of electrical contacts 22 which, when the memory apparatus 20 is received in an appropriate socket of the product, make contact with complementary contacts of the socket to provide electrical power to the apparatus 20 and to enable operations such as reading, writing and erasing of memory provided in the apparatus 20.

The memory in the apparatus 20 of this example comprises one or more NAND memory elements, shown generally at 24, arranged in one or more blocks of memory. Each block of memory comprises a plurality of pages 26, 28, 30, each of which contains a plurality (for example 512, 2048 or 4096) of bytes which can be used to store data. A command and data register 32 is provided which links the NAND memory element 24 to the contacts 22 to enable the NAND memory element 24 to be addressed by the product in which the memory apparatus 20 is installed.

An area 34 of the NAND memory element 24 of this example is reserved for configuration data of the memory apparatus 20, i.e. data relating to parameters of the memory apparatus 20. In one example the configuration data relates to various operating parameters of the memory chip. In one example the operating parameters includes parameters relating to the size or number of memory elements in the memory chip. The parameters relating to the size of memory elements in the memory chip could include any of: the size of memory pages in the memory chip, the number of pages per block of memory, or the number of sectors per page. In the same or another example the operating parameters include parameters relating to timing information for the memory chip. The operating parameters relating to timing information could include any of: the time taken by the device to erase a unit of memory, or to write to a unit of memory, or to read from a unit of memory.

In particular, in one example the configuration data includes information relating to any one or more of: the length in bytes of the memory address field used to access the contents of the NAND device; information on whether the device uses small or large blocks of memory (as the command set, page layout and bad block marking are different for these different types of devices); details of the size in bytes of pages of memory and the number of pages per block; and the number of sectors per page and the number of blocks in the device. In another example the configuration data may include timing information such as any one or more of: the time taken by the device to erase the memory; and the time to implement particular commands.

In a further example both timing information and information relating to the characteristics of the individual memory areas could be included as the configuration data.

Including the configuration data of the memory apparatus in a reserved area of the memory element as in the above examples simplifies the design and maintenance of the memory apparatus device driver, as the driver need not include a look up table of device identifiers and the configuration data of the devices associated with the identifiers. Thus, the size of the device driver is reduced, and there is no need to update the driver with new device identifiers and configuration data if additional devices are to be supported. This increases flexibility for manufacturers of products which use memory apparatus of this type, as any suitable memory apparatus can be supported without modification to or rebuilding of the driver.

In one example the area 34 of the NAND memory element 24 is separate from a main area which is used for storing user data such as contact information, photographs, music and the like, to ensure that the configuration data cannot accidentally be overwritten by user data. For additional security, the area 34 of the NAND memory element could be read-only, thus ensuring that even in the event of a memory addressing error which causes the apparatus 20 to attempt to write data to the area 34, the configuration data cannot be overwritten. In one embodiment, the reserved area 34 is in the first page 26 of the memory block, which is a “safe” page, as will be described below.

Typically, in a NAND flash memory device, the first page of the memory block is guaranteed by the manufacturer to be a “safe” page, i.e. to be error free, whilst the other pages of the memory block may contain errors. The first page of the memory block can be read using standard commands which are compatible with all NAND flash devices, and the address of the first page is typically known to or easily derivable by the driver 10. Thus, the first page of the memory block is often used to store important information. For example, in many products which employ NAND flash memory the first page of the NAND memory block contains a small piece of code known as the “first stage boot code” which is automatically loaded from the NAND memory into RAM of the product and executed. This executable code causes further information from the NAND flash memory to be loaded, taking into account possible bad pages in the NAND flash memory, such that pages that are known to be bad, in that they are corrupted or contain errors, are not used.

In one embodiment, the first stage boot code of the NAND flash memory apparatus 20 is arranged to be slightly smaller than the size, in bytes, of the “safe” first page 26 of the memory block. The remaining bytes of the first page 26 are used to store the configuration data relating to parameters of the memory apparatus 20. As the “safe” page is guaranteed to be error free, the configuration data should not be corrupted by errors or defects in the memory apparatus 20. In addition, as the safe area can be read by any product in which the memory apparatus is installed using only standard commands, the uncorrupted configuration data can easily be retrieved by a wide range of products. Thus, the uncorrupted configuration data relating to the parameters of the memory apparatus 20 can be read using standard commands by any product in which the memory apparatus 20 is used by reading the first page 26 of the memory block. Storing the configuration data relating to the parameters of the memory apparatus 20 on the apparatus 20 itself in this way obviates the need for a look-up table in the memory apparatus device driver 10, which reduces the size of the driver 10. Moreover, as the driver 10 has no look-up table, there is no need to rebuild it to update the look-up table with the device identifiers and configuration data of new NAND flash memory devices.

It will be appreciated that the area 34 of the first page 26 of the memory block reserved for the data relating to the parameters in this example should be at a predefined location to enable this data to be located and read from the memory quickly. Thus, manufacturers of products in which NAND flash memory devices such as the apparatus 20 are used may specify a location or address within the first page 26 at which the reserved area 34 should commence. The reserved area 34 should in this example be large enough to contain a complete set of configuration data of the memory apparatus 20, and the data itself should be in a standard format such that any product which uses the apparatus 20 is able successfully to read and decode the data.

In NAND flash memory devices such as the memory apparatus 20 there are typically an additional sixteen “spare” bytes for every 512 bytes of data. In the first page 26 of the apparatus 20 these spare bytes are unused, except for a single byte used to identify “bad” memory blocks, i.e. blocks which are corrupted or otherwise unusable. Thus, the first page 26 of the apparatus 20 has a spare area of fifteen bytes.

In an alternative embodiment, therefore, the reserved area 34 of the first page 26 of the apparatus 20 occupies the spare area comprising the fifteen unused bytes of the first page 26, and thus in this embodiment the spare area is used to store the configuration data relating to the parameters of the memory apparatus 20. This embodiment has the advantage that there is no need to reduce the size of the first stage boot code to accommodate the configuration data of the apparatus 20, whilst also offering reliable storage for the configuration data.

It is possible that in some NAND flash memory devices the first page 26 may not be the “safe” page, but that the “safe” page may be an alternative page of the memory. It will be appreciated that in these circumstances, it is advantageous for the area 34 reserved for the configuration data to be stored in this “safe” page rather than in the first page 26, to ensure that the configuration data is not corrupted by errors or defects in the memory apparatus 20.

It is also possible that an area of more than one page in a NAND memory device may be guaranteed to be a “safe” area, i.e. error-free. For example, several “safe” pages may be provided, or the whole of the first block may be guaranteed to be “safe”. It will be appreciated that in another example using such a device it is advantageous for the configuration data to be stored in part of this “safe” area.

In a further alternative embodiment, the reserved area 34 of the memory block is not located on the first page 26 of the apparatus 20, but is instead located at a predetermined address (or series of addresses) elsewhere in the memory apparatus 20. This avoids occupying memory in the first page 26, ensuring that the “safe” first page 26 is free for other important information such as the first stage boot code. It will be appreciated that in this embodiment the predetermined address should preferably be known to a product using the memory apparatus 20. This can be achieved by standardising the memory address at which the parameter data is stored for every NAND flash memory device, although this limits the flexibility of the device, as the particular memory address(es) chosen to contain the configuration data should preferably not be used for any other purpose.

In an alternative example, a command may be added to the command set used by the memory apparatus device driver 10, which command may be used to read the configuration data directly from the reserved area 34 or which may interrogate the apparatus 20 as to the address of the reserved area 34. This approach allows the configuration data to be read from the reserved area 34 whilst maintaining flexibility for manufacturers and users of memory apparatus 20, in that the address of the reserved area 34 can be selected by the manufacturer of the apparatus 20 and the configuration data can be returned directly by the memory apparatus 20 in response to the command issued by the device driver, or can be read directly from the address returned by the memory apparatus 20 in response to the command issued by the device driver 10. As for the previous embodiments, the reserved area 34 should be large enough to hold a complete set of configuration data relating to the parameters of the apparatus 20, and the configuration data should be in a standard format such that any product using the apparatus 20 is able successfully to read and decode the data.

As is mentioned above, a memory device driver 10 is used as an interface between the memory apparatus 20 and a higher-level application 12 which uses the memory resources of the memory apparatus 20. The device driver 10 typically includes a plurality of standard commands which allow data to be written to, read from or erased from the memory apparatus 20.

In the embodiments described above in which the reserved area 34 occupies part of the “safe” first page 26 of the memory apparatus 20, the configuration data contained in the reserved area 34 can be accessed using standard commands issued by the device driver 10. In one example, the configuration data in the reserved area 34 may be read by the device driver 10 by issuing an identification request (i.e. a command requesting that the memory apparatus 20 returns it identifier) followed by a dummy address such as zero. The term “dummy address” refers to a memory address value which does not reflect the actual location in memory of the data to be returned but rather is an address value which is interpreted by the apparatus 20 as meaning “the address of the configuration data”.

Alternatively, in another example the configuration data is read simply by issuing a “read” command accompanied by the address of the configuration data, if the configuration data is stored at a known address.

In another example, the same identification request, or alternatively a “read” command may be issued by the device driver 10 but may be followed by an address value which reflects the predetermined start address of the reserved area 34, with this command causing the apparatus 20 to return the whole of the configuration data from the reserved area 34. Alternatively, in a further example a separate command may be issued by the device driver 10 requesting that the memory apparatus 20 returns the start address of the reserved area 34, and subsequently a “read” command may be issued followed by the start address of the reserved area 34 to read the contents of the reserved area.

In a further alternative example, a specific “configuration data” command may be provided in the device driver 10 which, when issued to the memory apparatus 20 causes the memory apparatus 20 to return the configuration data. This has the advantage that the address of the configuration data need not be known to or requested by the device driver 10, and the configuration data can thus be obtained quickly and easily.

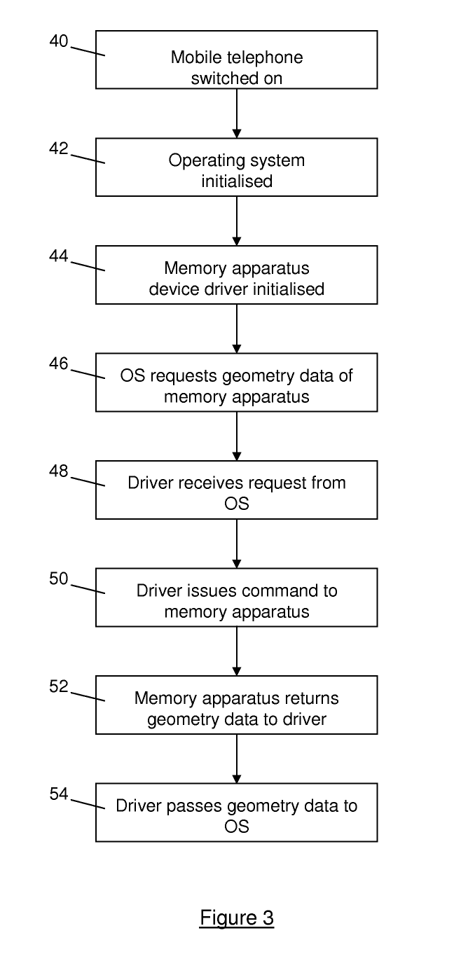

FIG. 3 is a flow diagram illustrating steps which may be taken by a product, in this example a mobile telephone, in which a memory apparatus 20 such as described in the examples above is installed.

In this example the mobile telephone is switched on at step 40, causing an operating system to be initialised at step 42. A memory apparatus device driver 10 is initialised at step 44. The operating system requires information relating to parameters of the memory apparatus 20 to ensure that memory operations are carried out correctly, so at step 46 the operating system makes a request for the configuration data of the memory apparatus 20. This request is received in the example at step 48 by the memory apparatus device driver 10, which translates it into a low-level command that can be understood by the memory apparatus 20. This low-level command is issued by the driver 10 to the memory apparatus 20 at step 50. The memory apparatus 20 returns the configuration data to the driver at step 52, and the driver passes the configuration data to the operating system at step 54.

If the configuration data is stored in a “safe” page of the memory apparatus 20, the step 50 of issuing a command to the memory apparatus 20 requesting the configuration data may be performed in a single operation, by issuing a read command with the address of the safe page, as is described above. Similarly, if the configuration data is stored outside the safe page of the memory apparatus 20 at a predetermined memory address which is known to the driver, the step 50 may be performed by issuing a read command with the known memory address. However, if the predetermined memory address is not known to the driver, it may be necessary for the driver to perform the step 50 in two stages, the first being to issue a command requesting that the memory apparatus 20 return the predetermined address of the configuration data and the second being to issue a read command with the address returned by the memory apparatus in response to the request.

Alternatively, the specific “configuration data” command may be issued by the device driver 10 at step 50, causing the memory apparatus to return the configuration data at step 52.

Although the embodiments described above refer to the specific example of NAND flash memory, it will be appreciated by those skilled in the art that the invention is equally applicable to other types of memory apparatus such as NOR flash memory.

1. An apparatus comprising:
a memory element having a plurality of memory areas, at least one of said memory areas being reserved for configuration data of the memory element; and
an input configured to receive a command issued by a memory device driver to access the configuration data in the reserved area.

2. An apparatus according to claim 1 wherein the memory element is arranged in one or more blocks of memory, each block comprising one or more pages.

3. An apparatus according to claim 1 wherein the area of the memory element which is reserved for the configuration data is a predefined area.

4. An apparatus according to claim 3 wherein the predefined area of the memory element which is reserved for the configuration data of the memory apparatus is in a safe area of the memory apparatus.

5. An apparatus according to claim 4 wherein the predefined area of the memory element which is reserved for the configuration data of the memory apparatus is in a spare area of the safe area.

6. An apparatus according to claim 3 wherein the predefined area is in a first page of the memory apparatus.

7. An apparatus according to claim 1 wherein the area of the memory element which is reserved for the configuration data is separate from an area of the memory element which is used for storing user data.

8. An apparatus according to claim 1 wherein the configuration data relates to operating characteristics of the memory chip.

9. An apparatus according to claim 1 wherein the command received at the input comprises an identification request and a memory address.

10. An apparatus according to claim 10 wherein the memory address is a dummy address.

11. An apparatus according to claim 3 wherein the command received at the input comprises an identification request and an address of the predefined area.

12. An apparatus according to claim 3 wherein the command received at the input comprises a request for the address of the predefined area.

13. An apparatus according to claim 1, wherein the command received at the input is a configuration request command which, when received by the memory apparatus, causes the memory apparatus to return the configuration data.

14. An apparatus according to claim 1 wherein the memory element is a flash memory chip.

15. A method comprising:
issuing a command to a memory element so as to access configuration data stored in the memory element relating to characteristics of the memory element; and
receiving, in response to the command, data pertaining to one or more characteristics of the configuration data.

16. A method according to claim 15, wherein the command issued to the memory element comprises an identification request and a memory address.

17. A method according to claim 15 wherein the command issued to the memory element comprises an identification request and an address of a predefined area of the memory element in which said configuration data is stored.

18. A method according to claim 15 wherein the command issued to the memory element comprises a request for the address of a predefined area of the memory element in which said configuration data is stored.

19. A method according to claim 15, wherein the command issued to the memory element comprises a configuration request command which, when received by the memory apparatus, causes the memory apparatus to return the configuration data

20. An apparatus comprising:
a memory element having a plurality of memory areas, at least one of said memory areas having configuration data relating to the memory element stored therein
an interface configured to communicate with the memory element so as to access the memory areas therein; and
a higher-level application that uses the memory element to store data;
wherein the interface is configured to issue a command to the memory element so as to access the configuration data stored in the memory element, and thereafter uses the configuration data to access the memory areas therein.
